(19) United States
(12) Patent Application Publication
(10) Pub. No.: US 2005/0119985 A1
(43) Pub. Date: Jun. 2, 2005

(54) Device, method and software for setting-up and maintaining knowledge applications

(76) Inventors: Johannes Wilhelmus Fransiscus Maria Van Grunsven, Uddelerveen (NL); Joris Bastiaan Latour, Bas Backerlaan (NL)

Correspondence Address: LADAS & PARRY, 26 WEST 61ST STREET, NEW YORK, NY, 10023, US

(21) Appl. No.: 10/493,782

(22) PCT Filed: Oct. 26, 2001
(86) PCT No.: PCT/NL01/00789

(51) Int. Cl. G06N 5/02; G06F 17/00; G06N 7/00; G06N 7/08

(52) U.S. Cl. 706/50; 706/59

(57) ABSTRACT

The invention relates to a method, device and software for setting-up, maintaining or using a variety of knowledge applications, wherein in one session a user enters a hierarchical structure or information as to contents with several levels of the hierarchical structure or both in a computer provided with data input means, by means of said data input means, wherein the computer is provided with software which during the session converts the entered hierarchical structure and the information as to contents into a knowledge base, and wherein the software during the session shows the hierarchical structure, the information as to contents or both on display means connected to the computer, in a manner selectively adjusted by the user.

The invention relates to a method, device and software for setting-up and maintaining knowledge applications.

In their own professional environment, knowledge workers are confronted more and more with large quantities of knowledge which have to be made explicit for both for their own use and for others and which require management continuously.

The source of knowledge is the human mind. In there it has an implicit and only limited structure. In order to transfer knowledge to others the knowledge has to be structured.

Structuring knowledge may in principle take place in various ways, for instance based on a process or based on a hierarchic structure. Many of the existing knowledge systems have a process approach. For instance Decision Support Systems, but also various expert systems, the core of the system being formed by rules of thumb or arithmetic rules. These kinds of knowledge systems are characterized by the fact that they automatically generate knowledge.

In addition knowledge applications are known based on a hierarchic structure, but they do not have a fully operational knowledge file with self-defined properties in each included abstraction level, which moreover can be defined and flexibly adjusted by the users themselves. On the other hand hierarchic data bases are available but they do not have a system generator that is easy to handle.

At the moment the knowledge workers are lacking a simple automated aid by which means they are able to make their own knowledge applications themselves.

A possible solution is having applications built via lengthy and costly system developments, the result at its best being a rigidly operating system, whereas knowledge workers indeed have a need for a flexible application that they themselves can adjust as desired, because the process of knowledge development has to take place interactively.

It is an object of the invention to at least partially solve the drawbacks mentioned.

To that end the invention provides a method for setting-up, maintaining or using a variety of knowledge applications, wherein in one session a user enters a hierarchical structure or information as to contents with several levels of the hierarchical structure or both in a computer provided with data input means, by means of said data input means, wherein the computer is provided with software which during the session converts the entered hierarchical structure and the information as to contents into a knowledge base, and wherein the software during the session shows the hierarchical structure, the information as to contents or both on display means connected to the computer, in a manner selectively adjusted by the user. Additionally the invention relates to a device for setting up or maintaining a knowledge application, comprising a data processing device, data storage means connected thereto, data input means and display means, and software comprising:
a user connection routine for entering a hierarchical structure and information as to contents by a user by means of the data input means with the several hierarchical levels by a user,
a browser routine for making both the structure and the information as to contents visible on display means in a selectively adjustable manner by a user,
a system generator routine for by means of the data processing device converting the structure entered by means of the user connection routine as the information as to contents into a knowledge base and storing the knowledge base on the data storage means. In addition the invention relates to software for setting-up and maintaining a knowledge application, comprising:
a user connection routine to enter a hierarchical structure and information as to contents with the several hierarchical levels by a user,
a browser routine to make both the structure and the information as to contents visible on display means in a selectively adjustable manner by a user,
a system generator routine for converting a hierarchical structure and the information as to contents entered by means of the user connection routine into a knowledge base.

The present invention offers knowledge workers an instrument by which means they are able to develop, use and manage their hierarchically structured knowledge applications themselves.

By introducing a hierarchical structure, knowledge can be understood better, opened up and managed. Said structure is built up from abstract to particular, in which often various hierarchical levels can be distinguished. At each level specific knowledge can be distinguished, thus resulting in a fan of ever increasing particular knowledge.

The present invention supports the hierarchically structured thinking in the creation or ordering of knowledge in a simple though powerful manner. The present invention results in an aid for rendering the available knowledge explicit in a structured manner. In an embodiment the use of arithmetic rules is supported.

The device or the method or the software according to the invention can be implemented as automated aid for desk top computers. In this way knowledge workers are able to build, use and manage their own knowledge applications. The device according to the invention thus is an automated application generator (systems generator) by which means hierarchic, flexible data bases (knowledge bases) can be developed in a very simple, user-friendly and quick manner.

The concept of knowledge base here regards on the one hand the traditional data bases having information as to contents such as numbers, texts, words and the like but also structured data bases having information as to contents such as electronic photos, sound extracts in an electronic form, scanned documents and the like.

In particular a method or device or software can be implemented in a simple manner when the software uses existing software parts for relational data bases. An example of such software is Microsoft ACCESS. Here the software creates a hierarchic data base implemented in a relational data base.

It should be clear that the device or method according to the invention can be used on so-called “stand-alone” computers, but it is also possible that the software is present on a remote computer, for instance as a server in a network or on the internet of an intranet, while the user works on a terminal or a local station and enters the data there and is shown said data on a display screen.

By means of the present invention it is possible to realise a knowledge application generator which automatically based on a created design (by defining the intended entity structure, entity occurrences, attribute structure and attribute occurrences) “behind the scenes” creates a knowledge base so that immediately and actually a fully operational knowledge base is realised. In this way deploying programmers for making knowledge bases and knowledge applications is no longer necessary.

The building takes place in a quick and simple manner (fast systems building). In this way not only the practise of prototyping (incremental development) that has existed for some time already is connected to, but an immediately and fully operational system is available with the development of the prototype, because an embodiment is provided with an automated knowledge base generator, which with each alteration that is included in the structure of the knowledge application also immediately includes an alteration in the knowledge base behind it, so that expanding the intended specifications and the actual use of the system take place simultaneously, interactively and iteratively. Therefore no fundamental difference has to be made any more between the development and the user stage.

In an embodiment of the method according to the invention the user enters an entity structure and a attribute structure as hierarchical structure, and enters entity occurrences and attribute occurrences as information as to contents, from which the software subsequently generates a hierarchical knowledge base. As a result the user is enabled to realise a complete knowledge application interactively.

In an embodiment of the method according to the invention the software presents on the display means at least one sub screen, selected from a sub screen for showing already entered entity structure components, a sub screen for showing already entered entity occurrences, a sub screen for showing the already entered attribute structure or a sub screen for showing attribute occurrences, or a combination of said sub screens.

In an embodiment of the method according to the invention the combination of sub screens that is shown is selectively adjusted by the user.

In an embodiment of the method according to the invention the software is provided with input routines to enable the user to interactively enter new components of the hierarchical structure or information as to contents via the input means, after which the software adjusts the knowledge base real-time.

In an embodiment of the method according to the invention the software shows the entity structure, the entity occurrences and the attribute structure each in a tree structure. In an embodiment of the method according to that aspect of the method according to the invention the software is provided with hide routines, wherein a user selects levels of the entity structure, entity occurrences or attribute structure, after which the software makes the underlying hierarchical levels visible or invisible.

In an embodiment of the method according to the invention the entity structure, the entity occurrences and the attribute structure consist of a tree structure of 1 out of n hierarchical relations.

In an embodiment of the method according to the invention the attribute structure comprises the attributes for each of the entities in the entity structure.

In an embodiment of the method according to the invention several users can start a knowledge application, and a user profile is attributed to each user, wherein it is indicated in the user profile which parts of the knowledge application the user can make visible and/or change.

In an embodiment of the device according to the invention the hierarchical structure is an entity structure and an attribute structure, and the information as to contents are entity occurrences and attribute occurrences, and the system generator routine is capable of converting the hierarchical structure and the information as to contents into a hierarchical knowledge base.

In an embodiment of the device according to the invention the browser routine has selection means for making sub screens visible on the display means in a selectively adjustable manner by a user, at least one sub screen to make the hierarchical structure visible, and at least one sub screen to make the information as to contents visible.

In an embodiment of the device according to the invention the browser routine simultaneously shows at least one sub screen showing the hierarchical structure, and at least one sub screen showing the information as to contents.

In an embodiment of the device according to the invention the software furthermore is provided with an indication routine for enabling the user by means of the data input means to indicate an element of the structure on the display means in a sub screen wherein the structure is visible, and with a display routine to show the information as to contents of an element of the structure indicated by means of the indication routine in a second sub screen.

In an embodiment of the device according to the invention the data storage means hold pre-programmed standard formats of the knowledge application that can be retrieved and be modified by a user.

In an embodiment of the device according to the invention the sub screens are mutually connected wherein, when the user selects a hierarchical level in a sub screen, the occurrences and structures belonging to said hierarchical level are shown in the sub screens in question that are visible on the display means.

In an embodiment of the software according to the invention the hierarchical structure is an entity structure and a attribute structure, and wherein the information as to contents are entity occurrences and attribute occurrences.

The software according to the invention can be included on a data carrier such as an optical disk (CD-ROM, DVD, etc.), a magnetic disk (hard disk, floppy, or the like), a memory that may or may not be permanent or semi-permanent (RAM, ROM, EPROM, etc.) or on a computer, be it stand alone or a server or client.

By means of the present invention in an embodiment knowledge applications are developed in a simple manner by:
entering a hierarchical structure of entity types;
entering entity occurrences which on the basis of the defined structure of entity types may occur;
entering the attribute structure which on the basis of the defined structure of the entity types consists of attribute definitions and standard values. The non-standard values have to be filled in in the screen section attribute occurrences. At least the following typology of attributes can be distinguished: text, numeric, date, percentage, yes/no, table, figure, file.

The present invention supports the complex process of knowledge management by permanently giving feedback to the user about on what (entity structure and entity occurrences) and about what (attribute structure and attribute occurrences) is worked. Said four-point feedback is of importance to analyse the complex process of knowledge management into units that can be comprehended by the user. To that end in an embodiment the displays are mutually connected so that they support an optimal drive. The user always receives feedback about where in the operative screen he is active with the cursor. The entity structure in an embodiment then indicates by means of a marking which level is being worked at and on. In a further embodiment the structure as to contents indicates by means of a marking which subject is being worked on. In a further embodiment the attribute structure indicates which characteristics of the subject are being viewed.

Certain numeric defined values of attributes may in an embodiment (with a process function/dynamic function) be coupled to a value which is defined at a higher hierarchical level of the entity occurrences. The coupling then automatically leads to the calculation of the value at the higher level. Here various mathematical and logic standard operations can be used (such as adding, calculating averages and percentages).

The invention in an embodiment has possibilities to be able to select the entered knowledge, and to group, order, prioritise and mathematically process them.

The invention in an embodiment comprises presentation possibilities to process the entered knowledge, as well as various performance functions. The knowledge application in a particular embodiment thereof contains support to import data from knowledge bases in order to support fast filling in on the attribute level.

In an embodiment the invention has the facility to be used by several users. Here it can be indicated which type of use is granted to the user (designing, viewing, filling in, analysing) and at which level of the basis structure, the structure as to contents or the attributes this use is related to.

As regards the basis structure in an embodiment the following extra user options hold good:
In the basis structure the possibility is given via an optional screen to enter definitions of the concepts used in the basis structure.
Via the entity type structure can be managed, which part of the structure as to contents has to be opened or closed.

In an embodiment in the operative screen the functions cut, paste copy and delete can be available.

In an embodiment when defining attributes the following extra user options hold good:
Indicating to what extent attributes are compulsory or optional to be filled in by the user.
Indicating to what extent attributes by the user consist of open questions or of shut questions, the user having to fill in a questionnaire made by the manager/designer.

The invention in a specific embodiment comprises a number of pre-stored answers as to contents of frequently occurring hierarchical knowledge management subjects (formats) such as: business and management plans and various check lists for organisation development. Said formats each time describe a standard structure of the knowledge application in question.

By means of the present invention fully operational knowledge applications can be build in a simple manner. Said applications have the following generic characteristics:
highly structured (hierarchical structure)
highly user-friendly (intuitive system interface)
flexible to expand and to adjust (all parts of the system can be altered)
easy to open up, by automatically making an operational internet application.
all possibilities to process data further in WORD, ACCESS and EXCEL.

To that end the system in an embodiment is adapted to a Windows environment and knows simple import and export possibilities with for instance ACCESS, POWERPOINT, WORD and EXCEL (all MICROSOFT trademarks).

Examples of knowledge applications which by means of the present invention can be developed are:
applications for specific knowledge opening up
prototype applications
meta systems
business plans
policy plans
management systems for carrying out plans
internet sites

In particular when building an internet application in which a knowledge application has been integrated in an internet site, an embodiment of the invention offers particular advantages. As the invention offers the possibility to make both the structure and the contents visible, if so desired simultaneously, and offers the possibility to adjust the structure and/or the contents, and offers the possibility to effect the adjustment immediately in the knowledge application, the possibility arises to adjust an internet site while browsing. In this specific use it is namely possible to make the hierarchical levels visible and to adjust them, to add information as to contents to each (either new or existing) level, and immediately and automatically adjust the underlying files.

The invention is further elucidated on the basis of an exemplary embodiment of software according to the invention in which:

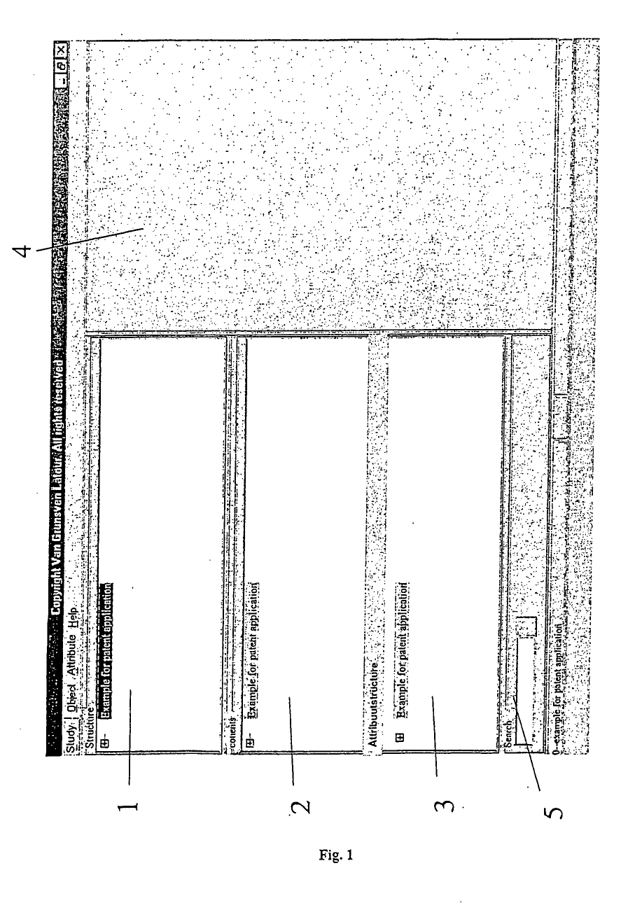

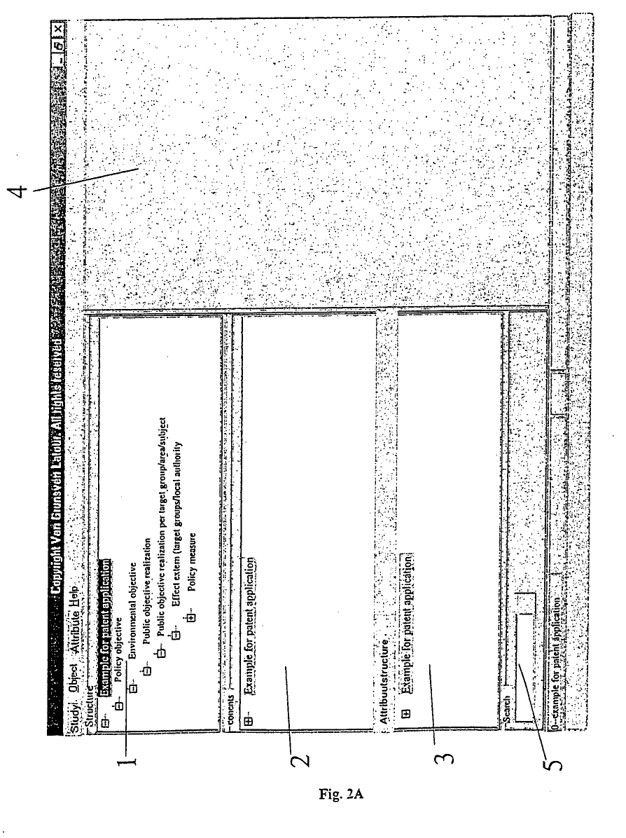

FIG. 1 shows a user interface;

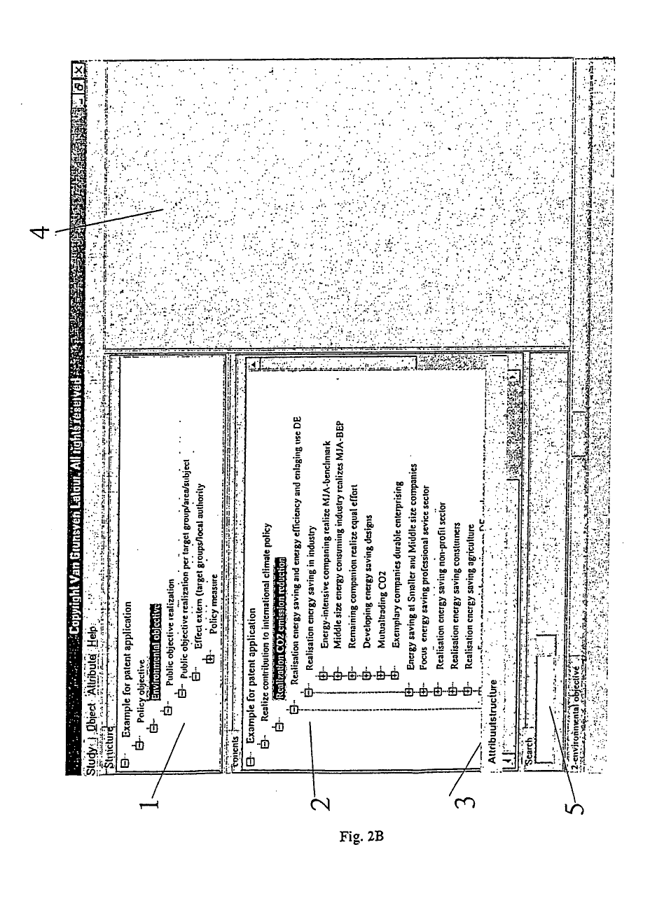

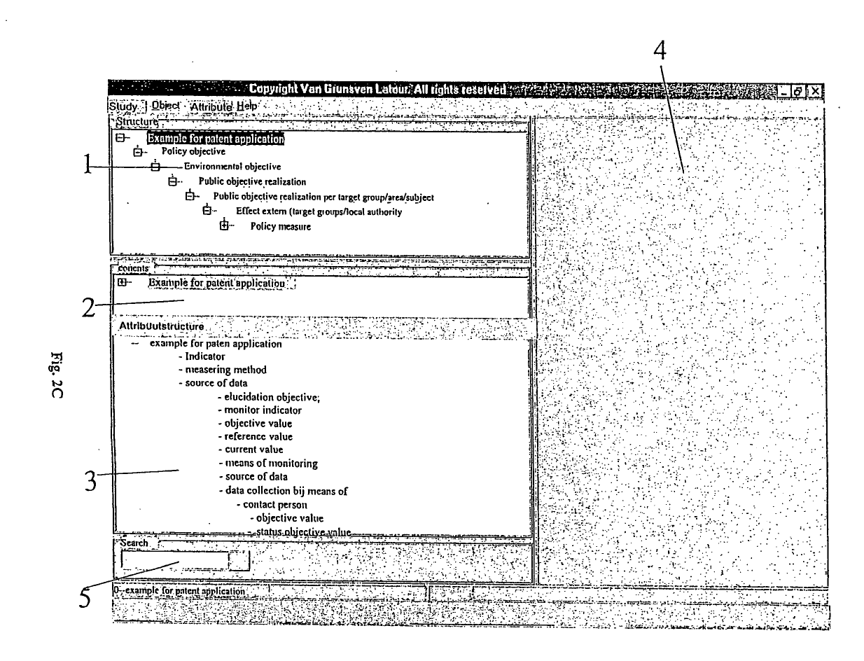

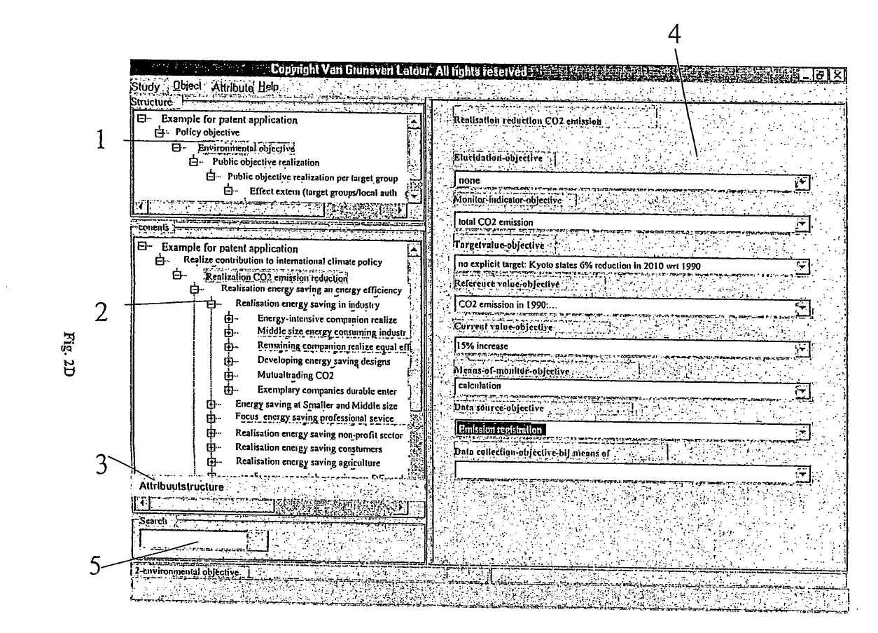

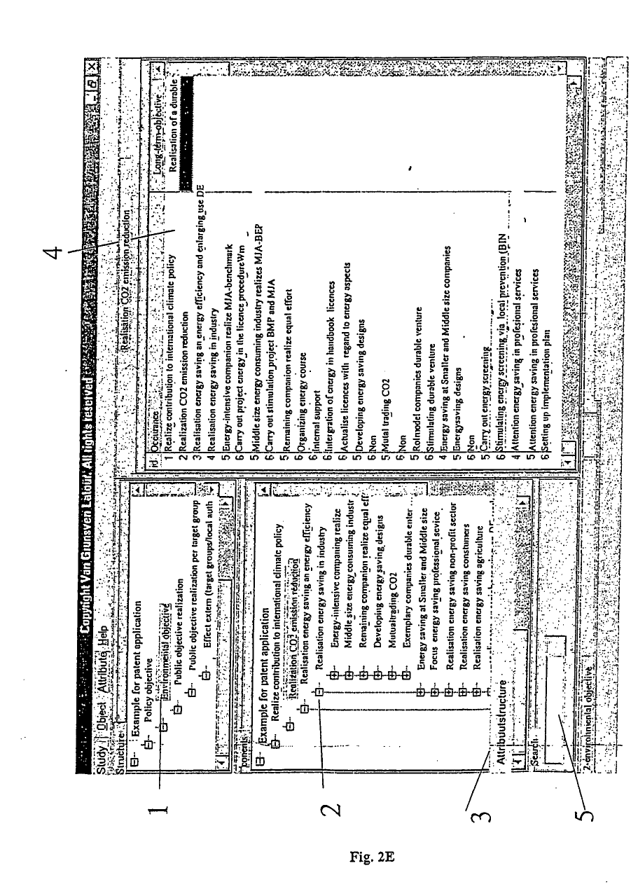

FIGS. 2A-2E show various stages of filled in help screens or sub screens.

In an embodiment the software according to the present invention has its own simple system interface, in which actually only one operative screen us used. This screen is built up as follows, as can be seen in FIG. 1.

The main screen or operative screen 0 is built up as follows. On the left hand side of the main screen 0 three sub screens 1, 2 and 3 have been defined. By means of said sub screens the knowledge structure is built up, by defining the entity structure in the entity structure sub screen 1, the entity occurrences in the entity occurrences sub screen 2, and the attribute structure in the attribute sub screen 3. Said sub screens can be opened and closed as desired by the user by means of mouse operations. The right hand part of the main screen contains the knowledge attributes, which belong to a specific entity occurrence in the knowledge attribute sub screen 4.

Both the entity structure, the entity occurrences and the attribute structure each have a hierarchical structure (tree view).

Each sub screen is filled in separately, defining a study being the start, that means, a name is given to the knowledge application. After that the entity structure and after that (if desired iteratively) the entity occurrences and the attribute structure are made within the study. Finally the screen with the attribute occurrences is filled in. This takes place in this exemplary user interface in a manner that is described below in the description of FIGS. 2A-2E. First of all the elements which are filled in the sub screens are further elucidated.

Below each of the sub screens is typified further:

1. Entity Structure

The first sub screen 1, having the entity structure, titled “Structure”, serves to name the basis structure of the hierarchy. The basis structure consists of an assembly of a number of levels that are hierarchically coupled to each other. This takes place by 1: defining n mother-daughter relations: each mother can have more daughters defined, but each time only one underlying level can be coupled to a higher level. The names of the levels and the number of levels can be adjusted by the user. The basis structure gives the building plan for the hierarchical knowledge base.

2. Entity Occurrences

The second sub screen 2 having the entity occurrences, titled “Contents”, serves to indicate the structure as to contents of the knowledge base. The structure as to contents at a maximum has the same number of levels that has been given to the basis structure. Per level several fillings-in or meanings can be given. The structure as to contents is meant to fill in the hierarchical knowledge base in terms of the relevant occurrences. The structure as to contents is specific for the study and has to be filled in/processed by the user.

3. Attribute Structure

The third sub screen 3 having the attribute structure, titled “Attribute”, serves to name which properties can be filled in and managed at which hierarchical level. Here for each level of the basis structure it is indicated which attributes have to be created in the knowledge base and which type of data are included in there. The next type of data can be distinguished: text, number, text files, graphic files, tables and other files. Several properties per level can be distinguished.

4. Attribute occurrences

The fourth sub screen 4 having attribute occurrences, here empty and not further indicated, serves to be able to fill in, view, manage and process the information as to contents of the properties.

With the screens the user is able to name, design, manage and analyse his basis structure, subjects as to contents and the properties of the study.

The setting-up of the knowledge application is indicated below by means of the FIGS. 2A-2E. In FIG. 2A the sub screen 1 with the entity structure has been opened and a number of hierarchical levels has already been created and provided with a label. The sub screen 2 with the entity occurrences has also been opened here and the label for the highest level has been copied.

In this example, for that matter, an extra sub screen, search sub screen 5 is also visible. By means of this screen the entire knowledge application can be searched, for instance a word.

In FIG. 2B it can be seen that in the sub screen 2 of the entity occurrences already several entity occurrences have been filled in.

In the figure the coupling between the sub screens 1 and 2 can also be seen. In sub screen 1 it can be seen that the filling in of the entity structure level having the label “environment object” is worked on. It can also be seen that the actual input takes place in sub screen 2. In a wink of an eye it can therefore be seen at which level work takes place, where in the structure, and what the interconnections are. As extra option all structures can flexibly be “folded” open and closed here. As a result the underlying structures and the information as to contents can be made invisible to keep an overview.

In FIG. 2C it can be seen how a user has now also opened sub screen 3 and has already entered a part of the attribute structure. The coupling between the various sub screens can also be seen here. Said coupling offers the knowledge worker a further, thorough overview, so that he will not get confused by the multitude of information. It can be seen that the sub screen in which data can be entered, the active sub screen, is sub screen 2 with the entity occurrences. It can be seen that the active level of the entity structure is the upper level (in sub screen 1). In sub screen 2 the underlying levels are closed. Also the user has left the sub screen 3 with the attribute structure open. It can be seen that at the highest level in the entity structure several levels have been defined in the entity occurrences, which as already stated have all been closed. In the upper entity occurrence an attribute structure has been defined, which is shown in sub screen 3 of the attribute structure. In an embodiment, when the user goes down a level in sub screen 1, sub screen 2 will also be adjusted and will only show those entity occurrences that belong to said level of the entity structure.

In FIG. 2D it can be seen that the user has closed the sub screen 3 with the attribute structure. Adjacent to it sub screen 4 with the attribute occurrences has been made visible. It can be seen that all indicated in sub screen 1 with entity structure is that the level “environment object” is worked on. In sub screen 2 with the entity occurrences it can be seen that a number of hierarchically ordered entities occur at the level “environment object”. It can also be seen that at the level “realising CO2 emission reduction” is also worked on. This name is also copied in the head of sub screen 4. In addition it can be seen that the components of the attribute structure, relevant for that level, which could still be seen in FIG. 2C in sub screen 3, have been copied in sub screen 4. When creating, the formats are indicated, that means whether it regards text, or a digital photo, sound, a scanned document, or whatever format. In this example all attribute occurrences are simple lines of text.

In FIG. 2E an alternative display build-up of sub screen 4 can be seen. Here a matrix is shown with in the first column the entity occurrences belonging to the entity structure level environment object, and in the first row the attribute occurrences.

For that matter the software according to the present invention can also be used in the management of collections. It may for instance be possible to select an embodiment in which the number of hierarchical levels to be set is limited. In that case, but this goes in general as well for the present invention, there is question of an object oriented hierarchy instead of an object-action hierarchy as for instance presented in the figure description.

It may be clear that the above description is included to illustrate the operation of preferred embodiments of the invention, and not to limit the scope of the invention. The scope of the invention is only limited by the claims below. Starting from the elucidation above, many variations which fall under the spirit and the scope of the present invention will be evident to an expert.

1. A method for setting-up, maintaining or using a variety of knowledge applications, wherein in one session a user enters a hierarchical structure or information as to contents with several levels of the hierarchical structure or both in a computer provided with data input means, by means of said data input means, wherein the computer is provided with software which during the session converts the entered hierarchical structure and the information as to contents into a knowledge base, and wherein the software during the session shows the hierarchical structure, the information as to contents or both on display means connected to the computer, in a manner selectively adjusted by the user.

2. The method according to claim 1, wherein the user enters an entity structure and a attribute structure as hierarchical structure, and enters entity occurrences and attribute occurrences as information as to contents, from which the software subsequently generates a hierarchical knowledge base.

3. The method according to claim 1, wherein on the display means the software presents at least one sub screen, selected from a sub screen for showing already entered entity structure components, a sub screen for showing already entered entity occurrences, a sub screen for showing the already entered attribute structure or a sub screen for showing attribute occurrences, or a combination of said sub screens.

4. The method according to claim 3, wherein the combination of sub screens that is shown is selectively adjusted by the user.

5. The method according to claim 1, wherein the software is provided with input routines to enable the user to interactively enter new components of the hierarchical structure or information as to contents via the input means, after which the software adjusts the knowledge base real-time.

6. The method according to claim 1, wherein the software shows the entity structure, the entity occurrence and the at-tribute structure each in a tree structure.

7. The method according to claim 6, wherein the software is provided with hide routines, wherein a user selects levels of the entity structure, entity occurrences or attribute structure, after which the software makes the underlying hierarchical levels visible or invisible.

8. The method according to claim 1, wherein the entity structure, the entity occurrences and the attribute structure consist of a tree structure of 1 out of n hierarchical relations.

9. The method according to claim 1, wherein the attribute structure comprises the attributes for each of the entities in the entity structure.

10. The method according to claim 1, wherein several users can start a knowledge application, and wherein a user profile is attributed to each user, wherein it is indicated in the user profile which parts of the knowledge application the user can make visible and/or change.

11. A device for setting up or maintaining a knowledge application, comprising a data processing device, data storage means connected thereto, data input means and display means, and software comprising:
a user connection routine for entering a hierarchical structure and information as to contents by a user by means of the data input means with the several hierarchical levels by a user,
a browser routine for making both the structure and the information as to contents visible on display means in a selectively adjustable manner by a user,
a system generator routine for by means of the data processing device converting structure entered by means of the user connection routine as the information as to contents into a knowledge base and storing the knowledge base on the data storage means.

12. The device according to claim 11, wherein the hierarchical structure is an entity structure and a attribute structure, and the information as to con-tents are entity occurrences and attribute occurrences, wherein the system generator routine is capable of converting the hierarchical structure and the information as to contents into a hierarchical knowledge base.

13. The device according to claim 11, wherein the browser routine has selection means for making sub screens visible on the display means in a selectively adjustable manner by a user, at least one sub screen to make the hierarchical structure visible, and at least one sub screen to make the information as to contents visible.

14. The device according to claim 13, wherein the browser routine simultaneously shows at least one sub screen showing the hierarchical structure, and shows at least one sub screen showing the information as to contents.

15. The device according to claim 14, wherein the software furthermore is provided with an indication routine for enabling the user by means of the data input means to indicate an element of the structure on the display means in a sub screen wherein the structure is visible, and with a display routine to show the information as to contents of an element of the structure indicated by means of the indication routine in a second sub screen.

16. The device according to claim 11, wherein the data storage means hold pre-programmed standard formats of the knowledge application that can be retrieved and be modified by a user.

17. The device according to claim 11, wherein the sub screens are mutually connected wherein, when the user selects a hierarchical level in a sub screen, the occurrences and structures belonging to said hierarchical level are shown in the sub screens in question that are visible on the display means.

18. Software for setting up and maintaining a knowledge application, comprising:
a user connection routine to enter a hierarchical structure and information as to contents with the several hierarchical levels by a user,
a browser routine to make both the structure and the information as to contents visible on display means in a selectively adjustable manner by a user,
a system generator routine for converting a hierarchical structure and the information as to contents entered by means of the user connection routine into a knowledge base.

19. The software according to claim 18, wherein the hierarchical structure is an entity structure and a attribute structure, and wherein the information as to contents is entity occurrences and attribute occurrences.

20. A carrier provided with software for setting up and maintaining a knowledge application, comprising:
a user connection routine to enter a hierarchical structure and information as to contents with the several hierarchical levels by a user,
a browser routine to make both the structure and the information as to contents visible on display means in a selectively adjustable manner by a user,
a system generator routine for converting a hierarchical structure and the information as to contents entered by means of the user connection routine into a knowledge base.

21. A computer provided with data storage means provided with software for setting up and maintaining a knowledge application, comprising:
a user connection routine to enter a hierarchical structure and information as to contents with the several hierarchical levels by a user,
a browser routine to make both the structure and the information as to contents visible on display means in a selectively adjustable manner by a user
a system generator routine for converting a hierarchical structure and the information as to contents entered by means of the user connection routine into a knowledge base.

22. The use of a knowledge application either made or maintained in accordance with the method for setting-up, maintaining or using a variety of knowledge applications, wherein in one session a user enters a hierarchical structure or information as to contents with several levels of the hierarchical structure or both in a computer provided with data input means by means of said data input means, wherein the computer is provided with software which during the session converts the entered hierarchical structure and the information as to contents into a knowledge base, and wherein the software during the session shows the hierarchical structure, the information as to contents or both on display means connected to the computer, in a manner selectively adjusted by the user.

23.-24. (canceled)
